(19) United States
(12) Patent Application Publication
(10) Pub. No.: US 2018/0143673 A1
(43) Pub. Date: May 24, 2018

(54) ELECTROPLATED PHASE CHANGE DEVICE

(71) Applicant: Microsoft Technology Licensing, LLC, Redmond, WA (US)

(72) Inventors: Kurt Jenkins, Sammamish, WA (US); Andrew Douglas Delano, Woodinville, WA (US); Lincoln Ghioni, Redmond, WA (US); Jeffrey Taylor Stellman, Seattle, WA (US)

(21) Appl. No.: 15/359,544

(22) Filed: Nov. 22, 2016

(51) Int. Cl. G06F 1/20; F28F 21/08; C25D 3/38; C25D 3/12; C25D 17/00

(52) U.S. Cl. CPC G06F 1/206; F28F 21/089; F28F 21/085; F28F 21/087; B22D 17/00; C25D 3/12; C25D 17/00; F28F 2255/143; C25D 3/38

(57) ABSTRACT

Thermal management devices and systems, and corresponding manufacturing methods are described herein. A phase change thermal management device is manufactured with a method that includes forming a volume of a first material. The volume of the first material defines a chamber of the thermal management device and an inner surface of a port. A layer of a second material is electroplated on the volume of the first material. The volume of the first material is melted or dissolved, such that the electroplated layer of the second material forms the chamber and the port. The melted volume of the first material is removed via the port.

### BRIEF DESCRIPTION OF THE DRAWINGS

For a more complete understanding of the disclosure, reference is made to the following detailed description and accompanying drawing figures, in which like reference numerals may be used to identify like elements in the figures.

FIG. 1 is a flow diagram of a method for manufacturing a thermal management device in accordance with one example.

FIG. 2 depicts a front view of one example of a volume of a first material.

FIG. 3 depicts a top view of an example of a passive thermal management device.

FIG. 4 depicts cross section A-A′ of the passive thermal management device of FIG. 3.

FIG. 5 depicts cross section B-B′ of the passive thermal management device of FIG. 3.

FIG. 6 depicts a top view of a portion of a computing device including an example of a passive thermal management system.

FIG. 7 is a block diagram of a computing environment in accordance with one example for implementation of the disclosed methods or one or more electronic devices.

While the disclosed devices, systems, and methods are representative of embodiments in various forms, specific embodiments are illustrated in the drawings (and are hereafter described), with the understanding that the disclosure is intended to be illustrative, and is not intended to limit the claim scope to the specific embodiments described and illustrated herein.

### DETAILED DESCRIPTION

Current microprocessor design trends include designs having an increase in power, a decrease in size, and an increase in speed. This results in higher power in a smaller, faster microprocessor. Another trend is towards lightweight and compact electronic devices. As microprocessors become lighter, smaller, and more powerful, the microprocessors also generate more heat in a smaller space, making thermal management a greater concern than before.

The purpose of thermal management is to maintain the temperature of a device within a moderate range for optimal operation of the device. During operation, electronic devices dissipate power as heat that is to be removed from the device. Otherwise, the electronic device will get hotter and hotter until the electronic device is unable to perform effectively. When overheating, electronic devices run slowly. This can lead to eventual device failure and reduced service life.

As computing devices get smaller (e.g., thinner), thermal management becomes more of an issue. Heat may be dissipated from a computing device using forced and natural convection, conduction, and radiation as a way of cooling the computing device as a whole and a processor operating within the computing device. Depending on the thickness of the device, there may not be sufficient room within the device for active thermal management components such as, for example, fans. Passive thermal management may thus be relied on to cool the device. For example, buoyancy driven convection (i.e., natural convection) and radiation to the surroundings may be relied upon to cool the device.

Improved passive heat transfer from a computing device may be provided by a constant temperature process (e.g., condensation of a pure fluid such as water) on or near a surface of a housing of the computing device. For example, a phase change device (e.g., a vapor chamber) that is thermally connected to a heat generating component within the computing device may be positioned adjacent to the surface. Other methods of manufacturing a vapor chamber include etching, stamping, sintering, and diffusion bonding. These methods of manufacturing have size and shape constraints. For example, diffusion bonding may use at least 3 mm of material to seal a perimeter of the vapor chamber.

Disclosed herein are thinner phase change thermal management devices with fewer size and shape constraints compared to the prior art, and methods for manufacturing the same. A method for manufacturing a phase change thermal management device includes creating a negative volume using, for example, injection molding, and plating the negative volume with a layer of material such as, for example, copper. The negative volume is melted away with application of heat or is dissolved with a solvent in a chemical process, leaving a positive volume. Texturing may be applied to the negative volume, such that capillary features are formed on the positive volume when the negative volume is melted away. The negative volume may also include openings extending through the negative volume, such that support structures are formed when surfaces defining the openings are plated and the negative volume is melted away. The support structures prevent the phase change thermal management device from collapsing when a vacuum is pulled on the phase change thermal management device. The negative volume is shaped such that a port is formed when the negative volume is melted away. The phase change thermal management device may be emptied of the melted negative volume and may be filled with a working fluid via the port.

As an example, the thinner phase change thermal management device may be manufactured with a method that includes forming a volume of a first material. The volume of the first material defines a chamber of the thermal management device and an inner surface of a single port or inner surfaces of a number of ports, respectively. A layer of a second material is electroplated on the volume of the first material. The volume of the first material is melted or dissolved, such that the electroplated layer of the second material forms the chamber and the port. The melted volume of the first material is removed via the port.

Such heat dissipation apparatuses or systems have several potential end-uses or applications, including any electronic device having a passive or an active cooling component (e.g., fan). For example, the heat dissipation apparatus may be incorporated into personal computers, server computers, tablet or other handheld computing devices, laptop or mobile computers, gaming devices, communications devices such as mobile phones, multiprocessor systems, microprocessor-based systems, set top boxes, programmable consumer electronics, network PCs, minicomputers, mainframe computers, or audio or video media players. In certain examples, the heat dissipation apparatus may be incorporated within a wearable electronic device, where the device may be worn on or attached to a person's body or clothing. The wearable device may be attached to a person's shirt or jacket; worn on a person's wrist, ankle, waist, or head; or worn over their eyes or ears. Such wearable devices may include a watch, heart-rate monitor, activity tracker, or head-mounted display.

Using one or more of these features described in greater detail below, improved heat dissipation may be provided for the electronic device or a thinner electronic device may be provided. With the improved heat dissipation feature, a more powerful microprocessor may be installed for the electronic device, a thinner electronic device may be designed, a higher processing speed may be provided, the electronic device may be operated at a higher power for a longer period of time, or any combination thereof may be provided when compared to a similar electronic device without one or more of the improved heat dissipation features. In other words, the heat dissipation features described herein may provide improved thermal management for an electronic device such as a mobile phone, tablet computer, or laptop computer.

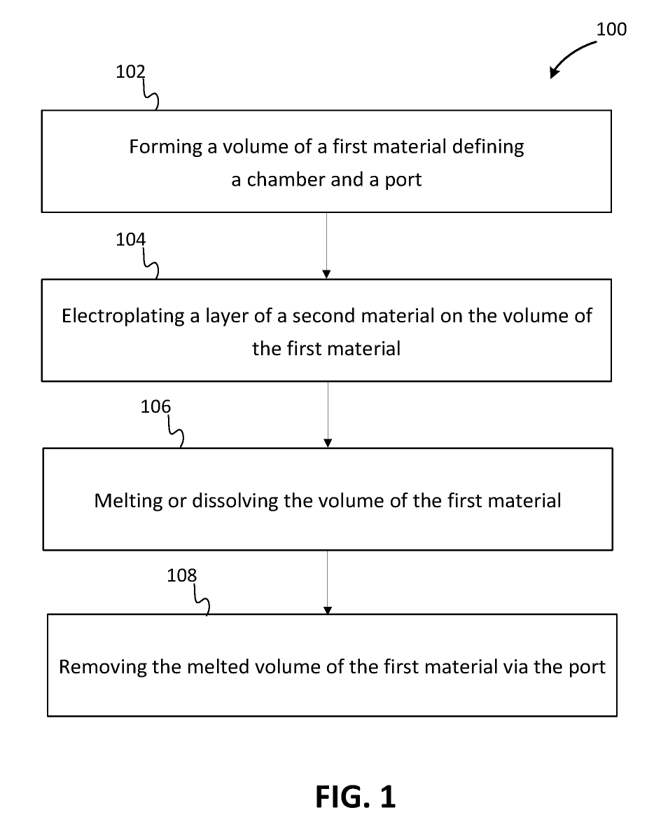

FIG. 1 shows a flowchart of one example of a method 100 for manufacturing a passive thermal management device of a computing device. The method 100 is implemented in the order shown, but other orders may be used. Additional, different, or fewer acts may be provided. Similar methods may be used for manufacturing a thermal management device. In other examples, at least some acts of the method 100 described in FIG. 1 may be performed to manufacture different types of thermal management devices such as, for example, a heat sink.

In act 102, a volume of a first material is formed. The volume of the first material defines a chamber of the thermal management device and an inner surface of a port. In one example, the volume of the first material is formed by injection molding the volume of the first material. Other manufacturing methods may be used to form the volume of the first material.

In one example, the volume of the first material is injection molded such that the volume of the first material includes one or more openings through the volume of the first material. In other words, the mold cavity may include posts that extend between a first side and a second side (e.g., a top and a bottom) of the mold cavity. In another example, the plurality of openings through the volume of the first material are formed through the volume after the volume is injection molded. The plurality of openings may be formed by, for example, drilling.

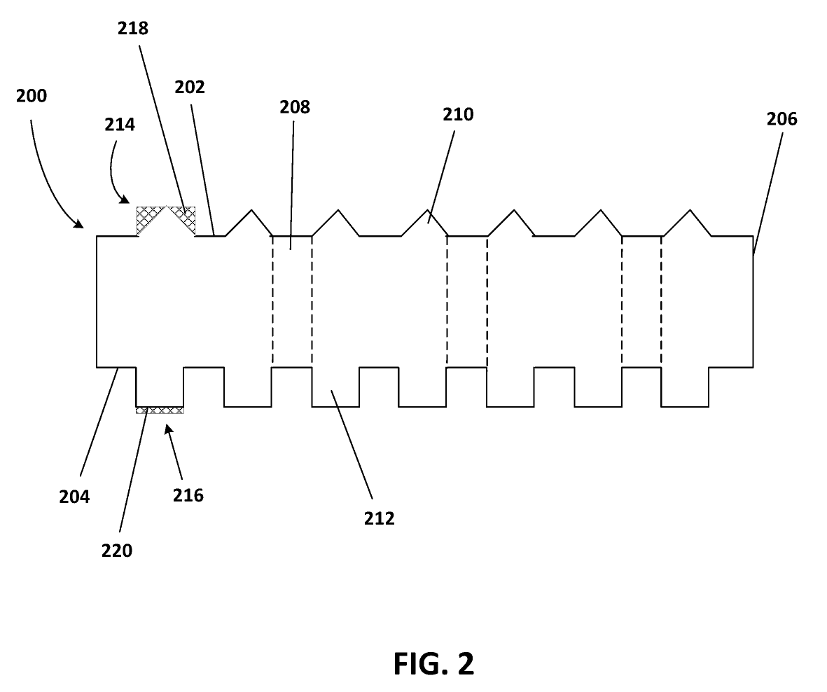

FIG. 2 shows a front view of one example of the volume of the first material 200. The volume of the first material 200 may include a first side 202, a second side 204, and at least one third side 206 (e.g., one third side for a cylindrical volume and more than one third side for other shaped volumes) extending between the first side 202 and the second side 204 of the volume 200. A plurality of openings 208 extend from the first side 202, to the second side 204, and through the volume of the first material 200. The plurality of openings 208 may be any number of shapes and/or sizes. For example, the plurality of openings 208 may be cylindrical. Each opening of the plurality of openings 208 may be the same shape and size. In other examples, at least a first subset of openings of the plurality of openings 208 has a different shape and/or size than a second subset of openings of the plurality of openings 208.

The volume of the first material 200 may be made of any number of materials. For example, the volume of the first material 200 may be made of any material that may be injection molded. In one example, the volume of the first material 200 is made of a wax (e.g., a paraffin-wax). In another example, the volume of the first material 200 is made of a thermoplastic. Other materials may be used for forming the volume of the first material 200. For example, the volume of the first material 200 may be made of a metal (e.g., an alloy) that has a low melting temperature. Examples of metals that have a low melting temperature include indium, tin, bismuth, zinc, and gallium.

Texturing 210, 212 may be positioned on the first side 202, the second side 204, and/or the at least one third side 206. The texturing 210, 212 may form capillary features in the passive thermal management device, as discussed below with reference to acts 104-108. The positioning of the texturing 210, 212 may include applying channels, bumps, ridges, different and/or additional features, or any combination thereof to the first side 202, the second side 204, and/or the at least one third side 206.

In the example shown in FIG. 2, the first side 202 includes first ridges 210 (e.g., first texturing), and the second side 204 includes second ridges 212 (e.g., second texturing). The first ridges 210 and the second ridges 212 produce different shaped capillary features in the passive thermal management device, respectively. For example, the first ridges 210 produce triangular shaped capillary features, and the second ridges 212 produce rectangular shaped capillary features. Other shaped capillary features (e.g., semi-cylindrical) may be produced. In one example, only one type of texturing (e.g., rectangular shaped ridges) is used across the entire volume of the first material 200. In another example, additional and/or different texturing is applied to the first side 202, the second side 204, and/or the third side 206 of the volume of the first material 200. The texturing may be uniformly positioned on the first side 202, the second side 204, and/or the third side 206 of the volume of the first material 200 (e.g., equal spacing between ridges on the volume of the first material 200). Alternatively, spacing between ridges on the volume of the first material 200 may be varied. The type and positioning of the texturing may be optimized for the specific geometry of the overall system architecture to promote phase change. Other texturing may be applied to the first side 202, the second side 204, and/or the third side 206 of the volume of the first material 200.

In one example, the texturing includes a first mesh 214 positioned at the first side 202 of the volume of the first material 200 and/or a second mesh 216 positioned at the second side 204 of the volume of the first material 200. In one example, one or more third meshes (not shown) are positioned at the at least one third side 206 of the volume of the first material 200. The first mesh 214, the second mesh 216, and/or the one or more third meshes may be metal meshes. For example, the first mesh 214, the second mesh 216, and/or the one or more third meshes may be made of copper or aluminum. Other materials may be used for the first mesh 214, the second mesh 216, and/or the third mesh. More or fewer meshes may be positioned on and/or in the volume of the first material 200.

In one example, the volume of the first material 200 is made of a wax, and the first mesh 214 is positioned within the wax at the first side 202 of the volume of the first material 200, and the second mesh 216 is positioned within the wax at the second side 204 of the volume of the first material 200. The first mesh 214 and the second mesh 216 may be positioned within the wax such that a portion 218 of the first mesh 214 and a portion 220 of the second mesh 216 extend out of the wax 200 at the first side 202 and the second side 204, respectively. The first mesh 214 and the second mesh 216, for example, may be pressed into the wax 200, or the first mesh 214 and the second mesh 216 may be positioned inside the mold before the volume of the first material 200 is injection molded, such that the wax 200 is formed around the first mesh 214 and the second mesh 216.

The first mesh 214 and the second mesh 216 may cover the entire first side 202 of the volume of the first material 200 and the entire second side 204 of the volume of the first material 200, respectively. In one example, the first mesh 214 covers less than all of the first side 202 of the volume of the first material 200 and/or the second mesh 216 covers less than all of the second side 204 of the volume of the first material 200. In another example, the first mesh 214 includes a number of individual meshes positioned within each of the first ridges 210, and/or the second mesh 216 includes a number of individual meshes positioned within each of the second ridges 212. Other positioning of the first mesh 214, the second mesh 216, and/or the third mesh may be provided.

In act 104, a layer of a second material is electroplated on the volume of the first material. Electroplating uses electrical current to apply, from an electrolyte solution, a thin metal coating on a surface. Metal atoms that plate the surface come from the electrolyte solution. The second material has a higher melting temperature than the first material. The second material may be any number of metals including, for example, copper, gold, silver, tin, zinc, cadmium, chromium, nickel, or platinum. For copper plating, for example, the electrolyte solution is made from a solution of a copper salt. Additional layers of different or the same material may be applied (e.g., a layer of a third material).

In the example where the first mesh and the second mesh are positioned within the volume of the first material, the layer of the second material is electroplated on the portions of the first mesh and the second mesh, respectively, extending out of the volume of the first material. The first mesh and the second mesh are thus physically connected to the layer of the second material.

In the example where the volume of the first material is made of wax, a layer of an electrically conducting material (e.g., a layer of a fourth material) is first applied to the volume of the first material. The layer of the third material is then electroplated with the layer of copper, for example. A layer of, for example, silver, carbon, nickel, or another electrically conductive material may be applied to the volume of the first material, such that current flows and thus plating is enabled. The layer of the electrically conducting material may be applied to the volume of the first material in any number of ways including, for example, by painting, static transfer, powder coating, or vapor deposition.

In the example where the volume of the first material is made of a metal (e.g., a metal with a low melting temperature), the layer of the electrically conducting material is not applied to the volume of the metal. After the volume of the metal is electroplated with the layer of the second material, the volume of the metal is melted and evacuated via the port. Any remaining material of the volume of the metal may be removed with a chemical process.

The layer of the second material encapsulates the volume of the first material such that an outer surface of the layer of the second material matches the shape and has a size similar to the volume of the first material (e.g., differing by the thickness of the layer of the second material around the volume of the first material). The layer of the second material has a first side, a second side, and at least one third side extending between the first side and the second side. In one example, the layer of the second material is electroplated on surfaces defining the plurality of openings through the volume of the first material, respectively. Electroplating the layer of the second material forms supports (e.g., hollow supports) extending from the first side of the layer of the second material to the second side of the layer of the second material.

The layer of the second material may be any number of thicknesses. Electroplating allows for thinner layers to be formed compared to prior art manufacturing methods such as, for example, etching, stamping, sintering, and diffusion bonding. In one example, the thickness of the layer of the second material is 0.15 mm. Other thicknesses may be provided. The thickness of the layer of the second material may be uniform across the entire outer surface of the volume of the first material. In one example, the thickness of the layer of the second material varies across the outer surface of the volume of the first material. For example, the layer of the second material may have a greater thickness at the surfaces defining the plurality of openings through the volume of the first material.

In one example, a layer of a third material is applied to the layer of the second material. The layer of the third material may be applied to the layer of the second material with, for example, electroplating. The layer of the third material may encapsulate the volume of the first material and the layer of the second material. In one example, the layer of the third material covers less than all of an outer surface of the layer of the second material. The layer of the third material may be equal, greater, or lesser thickness as compared to the layer of the second material. The layer of the third material may be any number of materials including, for example, nickel, silver, carbon, or another electrically conducting material. In one example, the layer of the third material is made of a metal (e.g., nickel) stronger than the metal (e.g., copper) that forms the layer of the second material. The layer of the third material may enhance stiffness of the passive thermal management device.

In act 106, the volume of the first material is melted or dissolved, such that the electroplated layer of the second material forms the chamber and the port. As discussed above, the first material may have a lower melting temperature than the second material. In one example, the first material has a lower melting temperature than the second material and the third material. Heat may be applied to the passive thermal management device to melt the volume of the first material. For example, heat may be applied to a number of passive thermal management devices manufactured according to the method of one or more of the present embodiments with an oven. The passive thermal management devices may be placed in the oven until the melting temperature of the volume of the first material is reached, and the volume of the first material melts. Heat may be applied to the passive thermal management devices in other ways to melt the volume of the first material. In one example, the volume of the first material is dissolved with a chemical solvent.

Once the volume of the first material is melted, at least the layer of the second material remains. In other examples, additional layers of material (e.g., the layer of the third material) remain. The layer of the second material forms the chamber and the port. Once the texturing formed on the volume of the first material is melted away, capillary features remain. In one example, the first mesh and/or the second mesh remain when the volume of the first material is melted away.

In act 108, the melted volume of the first material is removed via the port. In one example, a vacuum is applied to the port to remove the volume of the first material from the chamber formed by the layer of the second material. Alternatively or additionally, the passive thermal management device may be positioned such that gravity aids in the removal of the volume of the first material via the port. The volume of the first material may be collected and reused for manufacturing additional passive thermal management devices.

In the example where a solvent is used to dissolve the volume of the first material, the port or multiple ports formed by the layer of the second material are used to inject the solvent and vent out waste material (e.g., including the volume of the first material and the solvent).

The method may include additional, fewer, and/or different acts. For example, the method may also include applying an acid wash to surfaces forming the chamber to remove the layer of the fourth material (e.g., the layer of the electrically conducting material applied to aid in the electroplating of the volume of the first material). The method may also include pulling a vacuum in the chamber formed by the layer of the second material. The support structures formed within the plurality of openings through the volume of the first material prevent the layer of the second material from collapsing when the vacuum is pulled. The method may also include filling the chamber with a working fluid such as, for example, water or ammonia via the port, and sealing the chamber of the passive thermal management device. The port of may be sealed by applying a force to an outer surface of the port to close the opening through the port.

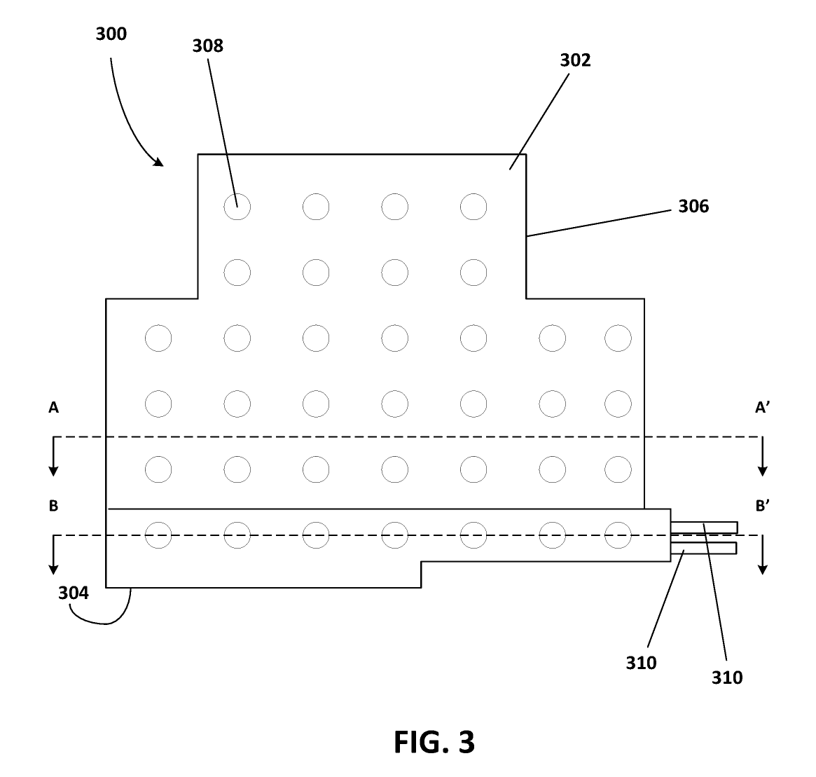

FIG. 3 shows one example of a passive thermal management device 300 (e.g., a phase change device such as a vapor chamber) manufactured with a method of one or more of the present examples. The vapor chamber 300 includes a first side 302, a second side 304, and at least one third side 306 (e.g., 12 third sides 306) that extends between the first side 302 and the second side 304. The vapor chamber 300 may be any number of sizes and/or shapes. For example, the vapor chamber 300 is sized and shaped based on the computing device into which the vapor chamber 300 is installed.

The vapor chamber 300 includes a plurality of openings 308 extending from the first side 302, through the vapor chamber 300, to the second side 304. The plurality of openings 308 may include any number of openings (e.g., 36 openings). In one example, the vapor chamber 300 includes a single opening 308. The plurality of openings 308 may be any number of sizes and/or shapes. As shown in the example of FIG. 3, the plurality of openings 308 may be circular. Each opening of the plurality of openings 308 may have the same size and/or shape. Alternatively, at least a first subset of openings of the plurality of openings 308 may have a different size and/or shape compared to a second subset of openings of the plurality of openings 308. The plurality of openings 308 define inner surfaces of supports (e.g., hollow posts) within the vapor chamber 300. The posts structurally support the vapor chamber 300 from collapsing when, for example, a vacuum is pulled on the vapor chamber 300.

The vapor chamber 300 is made of any number of materials. For example, as discussed with reference to act 104 of FIG. 1 above, the vapor chamber 300 may be made of any number of metals including, for example, copper, gold, silver, tin, zinc, cadmium, chromium, nickel, platinum. The vapor chamber 300 may be made of layers of different materials. For example, the vapor chamber 300 may be made of layers of copper and nickel.

The vapor chamber 300 includes one or more ports 310 via which a vacuum is pulled, a melted volume of material (e.g., wax) is removed, and/or the vapor chamber 300 is filled with a working fluid. For example, the vapor chamber 300 may be filled with water or ammonia via the port 310 after the melted volume of wax is removed from the vapor chamber 300. In the example shown in FIG. 3, the one or more ports 310 include two ports. More or fewer ports 310 may be provided. The multiple ports 310 may aid in the removal of material (e.g., the melted volume of material) from the vapor chamber 300. For example, one port 310 may be used to push a fluid or a gas (e.g., compressed air) into the vapor chamber 300, and the other port 310 may be used to evacuate (e.g., remove waste) from the vapor chamber 300.

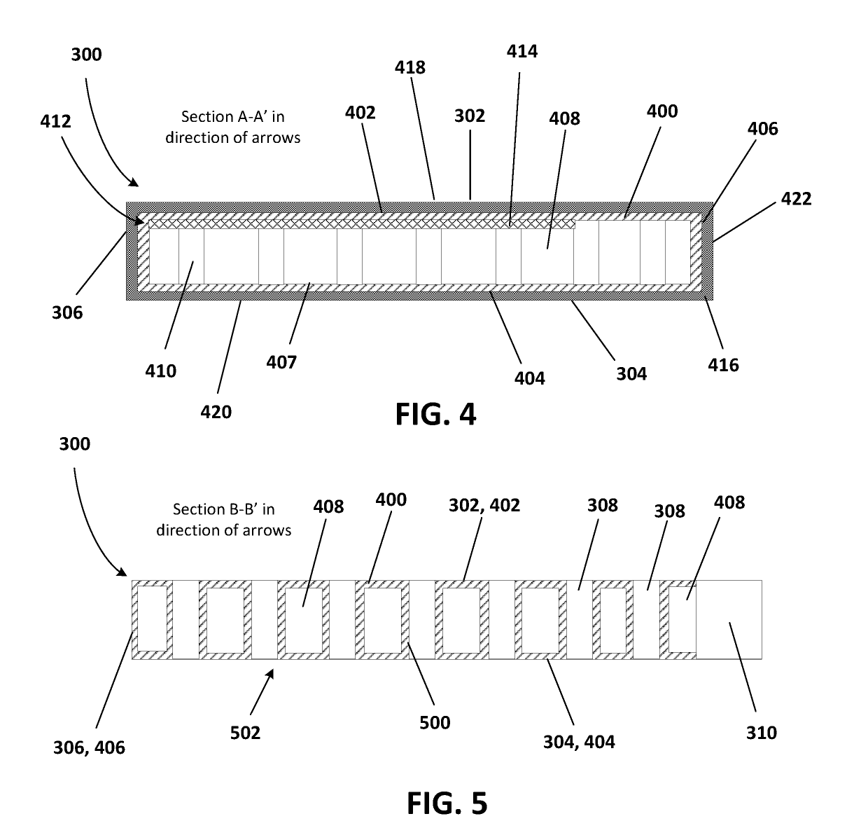

FIG. 4 shows cross section A-A′ of the vapor chamber 300 of FIG. 3. The vapor chamber 300 includes a layer of a second material 400. Outer surfaces of the layer of the second material 400 or another layer of material (e.g., a layer of a third material) define the first side 302, the second side 304, and the at least one third side 306 of the vapor chamber 300. The layer of the second material 400 includes a first side 402, a second side 404, and at least one third side 406 extending between the first side 402 and the second side 404. Inner surfaces 407 of the layer of the second material 400 define a chamber 408 that is fillable with the working fluid. The layer of the second material 400 may be any number of materials including, for example, a metal. For example, the layer of the second material 400 may be made of copper or silver.

Portions of the layer of the second material 400 extend between the first side 302 and the second side 304 such that the layer of the second material 400 forms hollow structural supports 410 (e.g., hollow posts) between the first side 302 and the second side 304 (see FIG. 5). The hollow posts 410 correspond with the plurality of openings 308 shown in FIG. 3.

The layer of the second material 400 may be any number of thicknesses. In one example, the layer of the second material 400 is approximately 0.15 millimeters thick. The layer of the second material 400 may be thinner or thicker than 0.15 millimeters. The thickness of the layer of the second material 400 may be uniform across the entire vapor chamber 300. Alternatively, the thickness of the layer of the second material 400 may vary across the vapor chamber 300. For example, with reference to FIG. 2, the layer of the second material 400 may be thicker in the channels between adjacent ridges of the texturing such that the first side 302 and the second side 304 of the vapor chamber 300 are flat. In other words, multiple layers of copper, for example, may be electroplated on the volume of the first material 200 (shown in FIG. 2) within the channels formed between adjacent ridges of the corresponding texturing to fill the channels and provide flat outer surfaces.

The vapor chamber 300 includes capillary features 412 adjacent to the first side 302, adjacent to the second side 304, and/or adjacent to the third side 306. The capillary features 412 may be adjacent to the first side 302, the second side 304, and/or the third side 306 in that the capillary features 412 are at positions within the chamber 408 closest to the first side 302, the second side 304, and/or the third side 306, respectively. In other words, the capillary features 412 abut one or more surfaces that define the chamber 408. The capillary features 412 may be formed as part of the layer of the second material 400, or the capillary features 412 may be physically connected to the layer of the second material 400 in that the layer of the second material 400 is electroplated directly onto a portion of the capillary features 412.

As examples, the capillary features 412 may include screen wick structures, open channels, channels covered with screens, an annulus behind a screen, an artery structure, a corrugated screen, other structures, or any combination thereof. In the example shown in FIG. 4, the capillary features 412 include a metal mesh 414 positioned adjacent to the first side 302 of the vapor chamber 300. The metal mesh 414 extends less than all of the way across the chamber 408 in the example shown in FIG. 4. In other examples, the metal mesh 414 may extend all of the way across the chamber 408 and/or additional metal meshes and/or other capillary features may be positioned adjacent to the first side 302, the second side 304, and/or the third side 306.

One or more additional layers of material may be disposed on the layer of the second material 400. For example, a layer of a third material 416 may be disposed on the layer of the second material 400 (an outer surface of the layer of the second material 400 including the first side 402, the second side 404, and the at least one third side 406). The layer of the third material 416 includes a first side 418, a second side 420, and at least one third side 422 extending between the first side 418 and the second side 420. In the example of FIG. 4, the at least one third side 422 of the layer of the third material 416 defines an outer perimeter of the vapor chamber 300. The layer of the third material 416 may be any number of materials including, for example, nickel. The third material may be stronger than the second material. In the example shown in FIG. 4, the layer of the third material 416 encapsulates the layer of the second material 400. In other examples, the layer of the third material 416 covers less than all of the layer of the second material 400. The layer of the third material 416 may have a constant thickness or a varied thickness across the vapor chamber 300.

FIG. 5 depicts cross section B-B′ of the vapor chamber 300 of FIG. 3. FIG. 5 shows the plurality of openings 308 extending between the first side 402 of the layer of the second material 400 and the second side 404 of the layer of the second material 400. In the example shown in FIGS. 3-5, at the cross-section B-B′, the vapor chamber 300 does not include the layer of the third material 416. In other words, at the cross-section B-B′, the first side 402, the second side 404, and the at least one third side 406 of the layer of the second material 400 act as the first side 302, the second side 304, and the at least one third side 306 of the vapor chamber 300, respectively. Portions 500 of the layer of the second material 400 define the plurality of openings 308 through the vapor chamber 300. The portions 500 of the layer of the second material 400 provide structural supports 502 (e.g., hollow posts) through the vapor chamber 300. The hollow posts 502 support the first side 302 and the second side 304 of the vapor chamber 300, such that the vapor chamber 300 does not collapse when a vacuum is pulled in the chamber 408 of the vapor chamber 300. The number and/or size of the hollow posts may be set based on the size and/or shape of the vapor chamber 300.

FIG. 5 also shows the port 310 via which the chamber 408 of the vapor chamber 300 may be filled with a working fluid. The chamber 408 of the vapor chamber 300 may be filled with any number of working fluids including, for example, water or ammonia. The port 310 may be sealed once a vacuum is pulled within the chamber 408 of the vapor chamber 300 and/or the chamber 408 of the vapor chamber 300 is filled with the working fluid.

The methods of manufacturing and the resultant phase change devices of the present examples provide advantages compared to the prior art. The capillary features that are formed via the injection-molded volume of wax, for example, have fewer geometrical limitations compared to the prior art. For example, the capillary features manufactured in this way may be highly controlled, where this is not possible with prior art processes. The layer of the second material, the layer of the third material, and/or additional layers that may be applied may have varying thickness and/or shape depending on overall system geometry. Thinner wall sections may be provided due to the use of electroplating to form walls of the passive thermal management device instead of processes of the prior art. Higher performance may thus be achieved in the same space occupied by a passive thermal management device of the prior art. Alternatively, the same level of performance may be achieved in a smaller space than with prior art passive thermal management devices. Since electroplating only coats surfaces, the support structures are hollow, which saves weight.

The perimeter of a passive thermal management device of the prior art may be sealed with diffusion bonding. Diffusion bonding utilizes a thick perimeter (e.g., 3 mm) for sealing. The perimeter (e.g., the at least one third side) of the passive thermal management device manufactured with one or more of the present embodiments may have the same thickness as the rest of the layer of the second material. This saves weight and space.

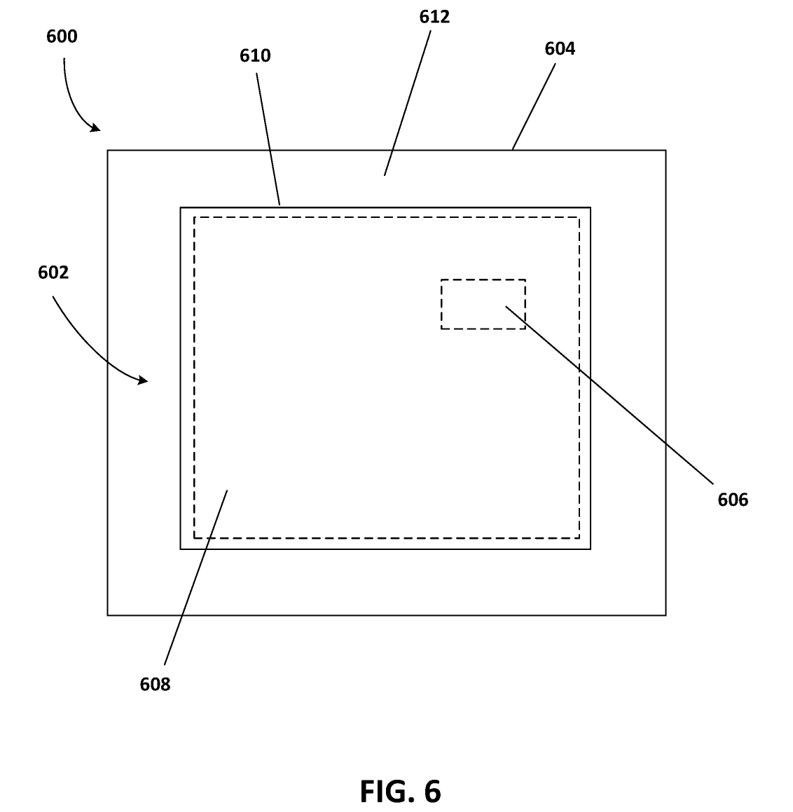

FIG. 6 depicts a top view of a portion of a computing device 600 including an example of a passive thermal management system 602 that is supported by a housing 604. In FIG. 6, a portion of the housing 604 is removed, and an interior of the housing 604 (e.g., largest cross-section of the housing) is shown. The computing device 600 may be any number of computing devices including, for example, a personal computer, a server computer, a tablet or other handheld computing device, a laptop or mobile computer, a communications device such as a mobile phone, a multiprocessor system, a microprocessor-based system, a set top box, a programmable consumer electronic device, a network PC, a minicomputer, a mainframe computer, or an audio and/or video media player. The passive thermal management system 602 is, for example, manufactured using one or more methods of the present examples.

The housing 604 supports at least the passive thermal management system 602 and a heat generating electrical device 606. The heat generating electrical device 606 may be any number of electrically powered devices including, for example, a processor, memory, a power supply, a graphics card, a hard drive, or other electrically powered devices. The heat generating electrical device 606 (e.g., a processor) may be supported by the housing 604 via, for example, a printed circuit board (PCB) 608 attached to and/or supported by the housing 604. The processor 606 is in communication with other electrical devices or components (not shown) of the computing device 600 via the PCB 608, for example. The computing device 600 may include a number of components not shown in FIG. 6 (e.g., a hard drive, a power supply, connectors).

The passive thermal management system 602 includes a phase change device 610. In the example shown in FIG. 6, the phase change device 610 is a vapor chamber. In other examples, the passive thermal management system 602 includes one or more additional and/or different phase change devices (e.g., one or more heat pipes).

The vapor chamber 610 abuts or is adjacent to the processor 606. The passive thermal management system 602 may be installed in a computing device where heat flux within the computing device does not reach levels high enough to prevent a working fluid within the vapor chamber 610 to return to a heat source (e.g., dry-out) such as, for example, the processor 606 (e.g., an evaporator). The working fluid may be any number of fluids including, for example, ammonia, alcohol, ethanol, or water.

The vapor chamber 610 may be any number of sizes and/or shapes. For example, as shown in FIG. 6, the vapor chamber 610 may be a rectangular flat vapor chamber (e.g., with rounder corners). The thickness of the vapor chamber 610 may be defined based on the thickness of the computing device 600 in which the passive thermal management system 602 is installed. A largest outer surface area of the vapor chamber 610 may approximately match a surface area (e.g., a largest surface area) of an inner surface 612 of the housing 604. In one example, the vapor chamber 610 is sized such that the largest outer surface area of the vapor chamber 610 is as large as will fit inside the housing 604. In other examples, the vapor chamber 610 is smaller.

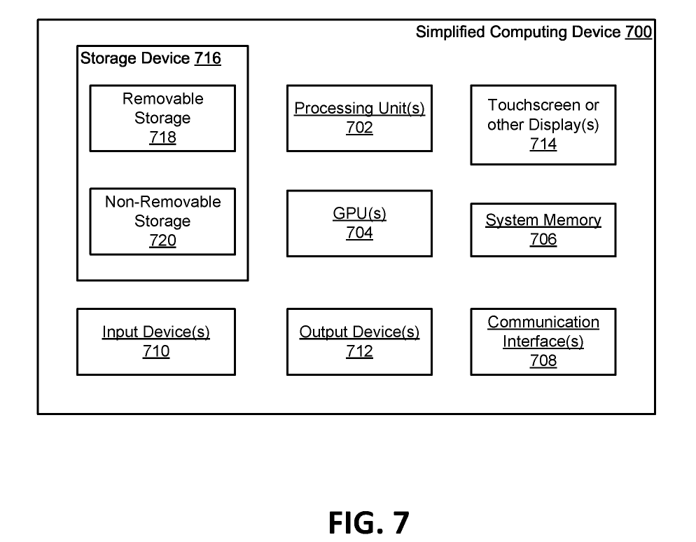

With reference to FIG. 7, a thermal management system, as described above, may be incorporated within an exemplary computing environment 700. The computing environment 700 may correspond with one of a wide variety of computing devices, including, but not limited to, personal computers (PCs), server computers, tablet and other handheld computing devices, laptop or mobile computers, communications devices such as mobile phones, multiprocessor systems, microprocessor-based systems, set top boxes, programmable consumer electronics, network PCs, minicomputers, mainframe computers, or audio or video media players. The thermal management system may be incorporated within a computing environment having an active cooling source (e.g., fan). In another example, the thermal management system may be incorporated within a computing environment not having an active cooling source.

The computing environment 700 has sufficient computational capability and system memory to enable basic computational operations. In this example, the computing environment 700 includes one or more processing units 702, which may be individually or collectively referred to herein as a processor. The computing environment 700 may also include one or more graphics processing units (GPUs) 704. The processor 702 and/or the GPU 704 may include integrated memory and/or be in communication with system memory 706. The processor 702 and/or the GPU 704 may be a specialized microprocessor, such as a digital signal processor (DSP), a very long instruction word (VLIW) processor, or other microcontroller, or may be a general purpose central processing unit (CPU) having one or more processing cores. The processor 702, the GPU 704, the system memory 706, and/or any other components of the computing environment 700 may be packaged or otherwise integrated as a system on a chip (SoC), application-specific integrated circuit (ASIC), or other integrated circuit or system.

The computing environment 700 may also include other components, such as, for example, a communications interface 708. One or more computer input devices 710 (e.g., pointing devices, keyboards, audio input devices, video input devices, haptic input devices, or devices for receiving wired or wireless data transmissions) may be provided. The input devices 710 may include one or more touch-sensitive surfaces, such as track pads. Various output devices 712, including touchscreen or touch-sensitive display(s) 714, may also be provided. The output devices 712 may include a variety of different audio output devices, video output devices, and/or devices for transmitting wired or wireless data transmissions.

The computing environment 700 may also include a variety of computer readable media for storage of information such as computer-readable or computer-executable instructions, data structures, program modules, or other data. Computer readable media may be any available media accessible via storage devices 716 and includes both volatile and nonvolatile media, whether in removable storage 718 and/or non-removable storage 720. Computer readable media may include computer storage media and communication media. Computer storage media may include both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the processing units of the computing environment 700.

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

In a first embodiment, a method for manufacturing a thermal management device includes forming a volume of a first material. The volume of the first material defines a chamber of the thermal management device and an inner surface of a port. The method also includes electroplating a layer of a second material on the volume of the first material. The method includes melting or dissolving the volume of the first material, such that the electroplated layer of the second material forms the chamber and the port, and removing the melted volume of the first material via the port.

In a second embodiment, with reference to the first embodiment, forming the volume includes injection molding the volume of the first material.

In a third embodiment, with reference to the second embodiment, injection molding the volume of the first material includes injection molding the volume of the first material such that a plurality of openings extend through the volume of the first material, from a first side of the volume of the first material to a second side of the volume of the first material. The first side is opposite the second side.

In a fourth embodiment, with reference to the third embodiment, electroplating the layer of the second material on the volume of the first material includes electroplating the layer of the second material on surfaces defining the plurality of openings.

In a fifth embodiment, with reference to the fourth embodiment, the method further includes applying texture on the first side of the volume, the second side of the volume, or the first side of the volume and the second side of the volume.

In a sixth embodiment, with reference to the fifth embodiment, applying texture includes positioning a first mesh at the first side of the volume of the first material, positioning a second mesh at the second side of the volume of the first material, or positioning the first mesh at the first side of the volume of the first material and positioning the second mesh at the second side of the volume of the first material. Electroplating the layer of the second material includes electroplating the layer of the second material on a portion of the first mesh, on a portion of the second mesh, or on the portion of the first mesh and the on the portion of the second mesh.

In a seventh embodiment, with reference to the first embodiment, the method further includes applying a layer of a third material on at least a portion of outer surfaces of the volume of the first material. Electroplating the layer of the second material on the volume of the first material includes electroplating the layer of the second material on the layer of the third material.

In an eighth embodiment, with reference to the seventh embodiment, the first material is a wax or a metal, the second material is copper or nickel, and the third material is silver, carbon, or aluminum.

In a ninth embodiment, with reference to the first embodiment, the first material is the metal. The metal has a lower melting temperature than the second material.

In a tenth embodiment, with reference to the first embodiment, the method further includes electroplating a layer of a third material on the layer of the second material.

In an eleventh embodiment, a phase change device includes a layer of a first material defining a chamber. The layer of the first material has a first side, a second side, and at least one third side extending from the first side to the second side. The at least one third side defines an outer perimeter of the phase change device. Portions of the layer of the first material extend between the first side and the second side such that the portions of the layer of the first material define a plurality of openings extending from the first side to the second side, respectively.

In a twelfth embodiment, with reference to the eleventh embodiment, the layer of the first material is approximately 0.15 mm thick.

In a thirteenth embodiment, with reference to the eleventh embodiment, the phase change device further includes first capillary features adjacent to the first side of the layer of the first material, second capillary features adjacent to the second side of the layer of the first material, or the first capillary features and the second capillary features.

In a fourteenth embodiment, with reference to the thirteenth embodiment, the first capillary features, the second capillary features, or the first capillary features and the second capillary features include, respectively, a mesh physically connected to the layer of the first material.

In a fifteenth embodiment, with reference to the eleventh embodiment, the phase change device further includes a layer of a second material disposed on the layer of the first material.

In a sixteenth embodiment, a computing device includes a heat generating electronic component, a housing that supports the heat generating electronic component, and a thermal management device physically connected to the heat generating electronic component and supported by the housing. The thermal management device includes a layer of a first material defining a chamber. The layer of the first material has a first side, a second side, and at least one third side extending from the first side to the second side. Portions of the layer of the first material extend between the first side and the second side such that the portions of the layer of the first material define a plurality of openings extending from the first side to the second side, respectively. The thermal management device further includes first capillary features adjacent to the first side of the layer of the first material, second capillary features adjacent to the second side of the layer of the first material, or the first capillary features and the second capillary features.

In a seventeenth embodiment, with reference to the sixteenth embodiment, the layer of the first material is approximately 0.15 millimeters thick.

In an eighteenth embodiment, with reference to the sixteenth embodiment, at least part of the first capillary features, the second capillary features, or the first capillary features and the second capillary features include, respectively, a metal mesh physically connected to the layer of the first material.

In a nineteenth embodiment, with reference to the sixteenth embodiment, the layer of the first material is made of copper. The thermal management device further includes a layer of a second material disposed on the layer of the first material. The second material is nickel.

In a twentieth embodiment, with reference to the sixteenth embodiment, the computing device further includes a fluid disposed within the chamber of the thermal management device.

In connection with any one of the aforementioned embodiments, the thermal management device or the method for manufacturing the thermal management device may alternatively or additionally include any combination of one or more of the previous embodiments.

The foregoing description is given for clearness of understanding only, and no unnecessary limitations should be understood therefrom, as modifications within the scope of the claims may be apparent to those having ordinary skill in the art.

1. A method for manufacturing a thermal management device, the method comprising:
forming a volume of a first material, the volume of the first material defining a chamber of the thermal management device and an inner surface of a port;
electroplating a layer of a second material on the volume of the first material;
melting or dissolving the volume of the first material, such that the electroplated layer of the second material forms the chamber and the port; and
removing the melted volume of the first material via the port.

2. The method of claim 1, wherein forming the volume comprises injection molding the volume of the first material.

3. The method of claim 2, wherein injection molding the volume of the first material comprises injection molding the volume of the first material such that openings extend through the volume of the first material, from a first side of the volume of the first material to a second side of the volume of the first material, the first side being opposite the second side.

4. The method of claim 3, wherein electroplating the layer of the second material on the volume of the first material comprises electroplating the layer of the second material on surfaces defining the openings.

5. The method of claim 4, further comprising applying texture on the first side of the volume, the second side of the volume, or the first side of the volume and the second side of the volume.

6. The method of claim 5, wherein applying texture comprises positioning a first mesh at the first side of the volume of the first material, positioning a second mesh at the second side of the volume of the first material, or positioning the first mesh at the first side of the volume of the first material and positioning the second mesh at the second side of the volume of the first material, and
wherein electroplating the layer of the second material comprises electroplating the layer of the second material on a portion of the first mesh, on a portion of the second mesh, or on the portion of the first mesh and the portion of the second mesh.

7. The method of claim 1, further comprising applying a layer of a third material on at least a portion of outer surfaces of the volume of the first material,
wherein electroplating the layer of the second material on the volume of the first material comprises electroplating the layer of the second material on the layer of the third material.

8. The method of claim 7, wherein the first material is a wax or a metal, the second material is copper or nickel, and the third material is silver, carbon, or aluminum.

9. The method of claim 1, wherein the first material is the metal, the metal having a lower melting temperature than the second material.

10. The method of claim 1, further comprising electroplating a layer of a third material on the layer of the second material.

11. A phase change device comprising:
a layer of a first material defining a chamber, the layer of the first material having a first side, a second side, and at least one third side extending from the first side to the second side, the at least one third side defining an outer perimeter of the phase change device,
wherein portions of the layer of the first material extend between the first side and the second side such that the portions of the layer of the first material define openings extending from the first side to the second side, respectively.

12. The phase change device of claim 11, wherein the layer of the first material is approximately 0.15 millimeters thick.

13. The phase change device of claim 11, further comprising first capillary features adjacent to the first side of the layer of the first material, second capillary features adjacent to the second side of the layer of the first material, or the first capillary features and the second capillary features.

14. The phase change device of claim 13, wherein the first capillary features, the second capillary features, or the first capillary features and the second capillary features comprise, respectively, a mesh physically connected to the layer of the first material.

15. The phase change device of claim 11, further comprising a layer of a second material disposed on the layer of the first material.

16. A computing device comprising:
a heat generating electronic component;
a housing that supports the heat generating electronic component; and
a thermal management device physically connected to the heat generating electronic component and supported by the housing, the thermal management device comprising:
a layer of a first material defining a chamber, the layer of the first material having a first side, a second side, and at least one third side extending from the first side to the second side, wherein portions of the layer of the first material extend between the first side and the second side such that the portions of the layer of the first material define one or more openings extending from the first side to the second side, respectively; and
first capillary features adjacent to the first side of the layer of the first material, second capillary features adjacent to the second side of the layer of the first material, or the first capillary features and the second capillary features.

17. The computing device of claim 16, wherein the layer of the first material is approximately 0.15 millimeters thick.

18. The computing device of claim 16, wherein at least part of the first capillary features, the second capillary features, or the first capillary features and the second capillary features comprise, respectively, a metal mesh physically connected to the layer of the first material.

19. The computing device of claim 16, wherein the layer of the first material is made of copper, and
wherein the thermal management device further comprises a layer of a second material disposed on the layer of the first material, the second material being nickel.

20. The computing device of claim 16, further comprising a fluid disposed within the chamber of the thermal management device.
